(19) United States
(12) Patent Application Publication
(10) Pub. No.: US 2010/0109191 A1
(43) Pub. Date: May 6, 2010

(54) METHOD FOR MAKING MULTI-LAYERED MOLDED ARTICLES

(75) Inventors: KUN-TSAN WU, Shindian (TW); LI-WEN TIEN, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/687,198

(22) Filed: Jan. 14, 2010

Related U.S. Application Data
(63) Continuation-in-part of application No. 12/168,236, filed on Jul. 7, 2008.

(30) Foreign Application Priority Data
Dec. 21, 2007 (CN) 200710203343.8

(51) Int. Cl. B29C 45/14

(52) U.S. Cl. 264/265

(57) ABSTRACT

A method of forming a multi-layered molded article is described. The method includes applying a soft material to a substrate, thereby forming a substrate with a soft layer thereon.

### CROSS-REFERENCE TO RELATED APPLICATION

This application is a continuation-in-part application of U.S. Ser. No. 12/168, 236, filed Jul. 7, 2008 the contents of which are hereby incorporated by reference. The parent application Ser. No. 12/168, 236 in turn claims the benefit of priority under 35 USC 119 from Chinese Patent Application 200710203343.8, filed on Dec. 21, 2007.

### BACKGROUND

1. Field of the Invention

The present invention relates to a method for making multi-layer molded articles.

2. Description of Related Art

Molded articles, such as molded shells, are widely used in many technological fields. One example is a molded shell used with a portable electronic device (e.g., a mobile phone) for protecting internal electronic components. Another example is a molded shell used with furniture (e.g., a mini sofa) to provide decoration.

The molded shells may include a plastic substrate having some kind of decorative and/or protective (hereinafter “second”) layer formed thereon. The molded shell may be made using an insert molding process. The second layer is placed in the mold cavity and then bonds to the molten plastic injected into the mold for forming the substrate.

Various difficulties may be faced when manufacturing this multi-layer molded article.

Therefore, there is room for improvement within the art.

### BRIEF DESCRIPTION OF THE DRAWINGS

Many aspects of the method for making the multi-layered molded article can be better understood with reference to the following drawings. The components in the drawings are not necessarily drawn to scale, the emphasis instead being placed upon clearly illustrating the principles of the method for making the multi-layered molded article. Moreover, in the drawings like reference numerals designate corresponding parts throughout the several views.

FIG. 1 shows an exploded, schematic view of an exemplary embodiment of the present multi-layered molded article;

FIG. 2 shows a schematic view of the soft layer positioned between a female mold portion and a male mold portion;

FIG. 3 shows a schematic view when a male mold portion is matingly engaged with the female mold portion of FIG. 2;

FIG. 4 shows a schematic view of the multi-layered molded article after molten material is injected into a mold cavity;

FIG. 5 shows a schematic view of a semi-manufactured article being cut by a punching machine; and

FIG. 6 is a cross-sectional view of the punch head.

### DETAILED DESCRIPTION OF THE EXEMPLARY EMBODIMENTS

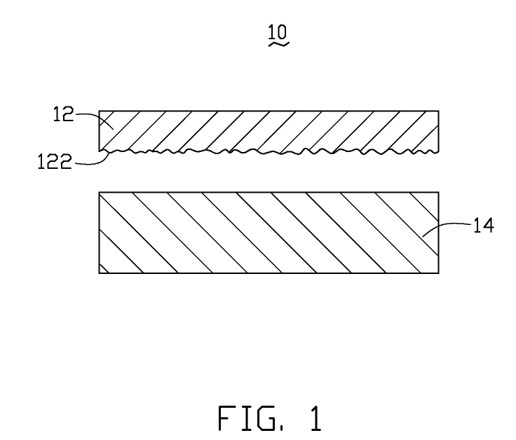

Referring to FIG. 1, an exemplary embodiment of a multi-layered molded article 10 is shown. Article 10 includes a soft layer 12 and a substrate 14 moldingly bonded to the soft layer 12.

The soft layer 12 can be made of a material that is soft relative to the substrate 14. Exemplary soft materials include leather (natural and artificial), all types of fabrics, woven clothes, textiles, and nylon. The soft layer has first and second surfaces. One surface of the soft layer gives the final molded article its tactility and aesthetics. The other surface of the soft layer 12 acts as a bonding surface 122 for bonding the soft layer 12 to the substrate 14. When the soft layer 12 is natural leather, typically, both the first and second surfaces are the natural leather. When the soft layer is an artificial leather, typically the first surface will be the artificial leather and the second surface will be a fabric base covering the artificial leather. The fabric base will be used as the bonding surface 122.

The bonding surface 122 should have a rough or coarse surface, formed by, for example, a plurality of tiny pores or projections (schematically shown). For some soft materials, the pores and projections of the bonding surface 122 may be a natural property of the material. For other soft materials, the pores and projections may be formed by grinding or sandblasting the bonding surface 122. The tiny pores and projections of the bonding surface 122 interlock with the molten material used to make substrate 14, thereby increasing the bonding of the soft layer 12 to the substrate 14.

The substrate 14 can be formed by injection molding a moldable material. The moldable material can be any of plastic, rubber, and silicone. The plastic material can be any of polyvinylchloride resin (PVC), polyethylene terephthalate (PET), acrylonitrile-butadiene-styrene (ABS), polycarbonate (PC), polyimide (PI), liquid crystal polymer (LCP), polyetherimide (PEI), polyphenylene sulfide (PPS), polystyrene (PS), polypropylene (PP). In particular, ABS and PC exhibit good adhesion to many softer materials.

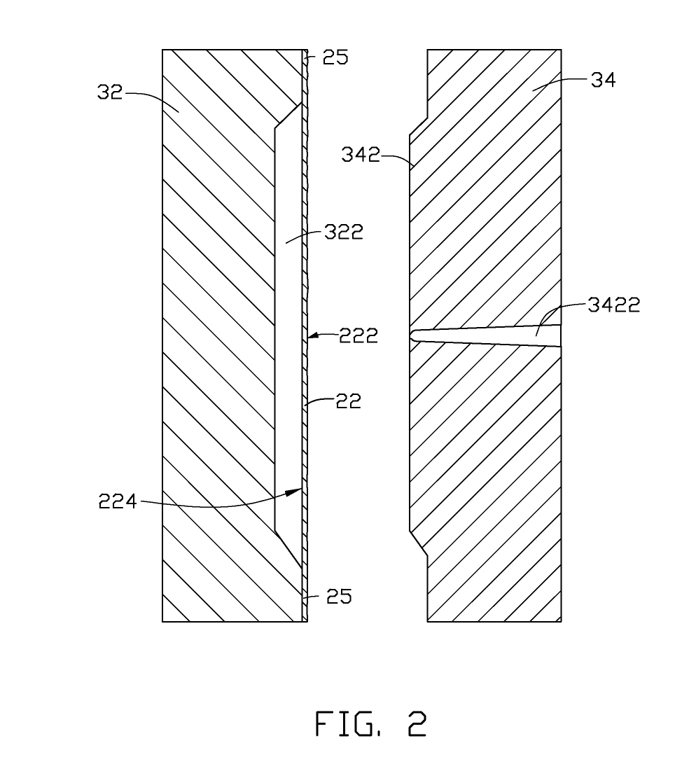

FIGS. 2-5 depict the steps of an exemplary method for preparing an exemplary multi-layered molded article 10. The soft layer 12, in the form of a soft material 22 is provided. The soft material 22 includes a first surface 222 and a second surface 224. The second surface 224 functions as the bonding surface 122 as previously described. In this exemplary embodiment, the soft material 22 is made of natural leather or artificial leather. The natural leather and artificial leather require the ability to endure the temperatures of the molten material which will be injected into the mold and are typically on the order of 300° C. temperature. The surface area of the soft material 22 is larger than the surface area the surface portion of the multi-layered molded article 10 to which a soft layer 12 is applied.

Referring to FIG. 2, an injection mold is provided. The injection mold includes a female mold portion 32 and a male mold portion 34, for mating with the female mold portion 32. The female mold portion 32 defines a recess 322. A protrusion 342 extends from the male portion 34. A runner 3422 is defined in a central area of the male mold portion 34. When the soft material 22 is positioned over/on the female mold portion 32, the soft material 22 includes a perimeter edge portion 25 freely placed on the female mold portion 32. The first surface 222 of the soft material 22 faces the male mold portion 34.

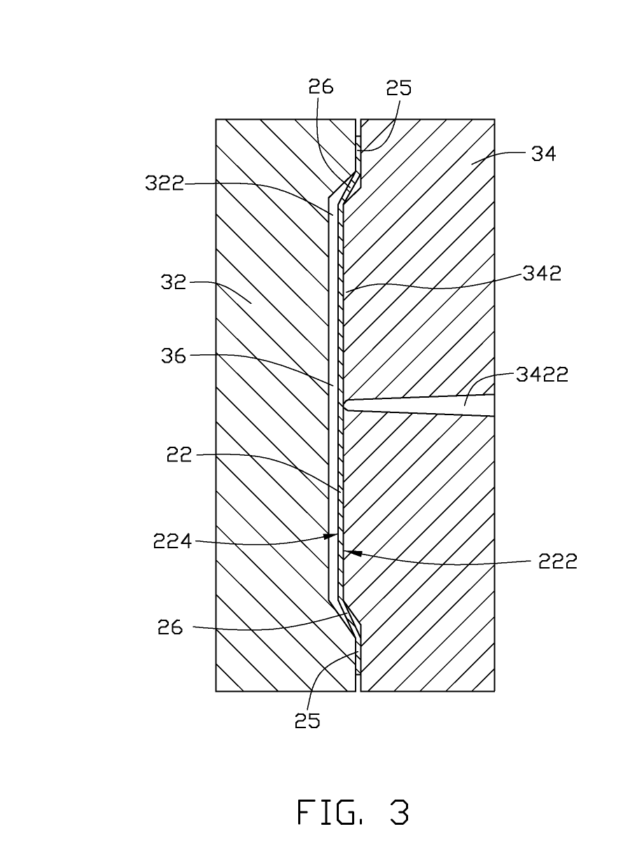

Referring to FIG. 3, when the female mold portion 32 mates with the male mold portion 34, a mold cavity 36 is defined between the female mold portion 32 and the male mold portion 34. However, before the mating, as the male mold portion 34 is moved towards the mating position with the female mold portion 32, protrusion 342 of the male mold portion comes into contact with, and begins pushing, the soft material 22 into the mold cavity. The deflection of the soft material 22 due to its being pushed by the protrusion 342 causes the perimeter edge portions 25 to be pulled toward the mold cavity 36. Since the soft material 22 is not fixed to the female mold portion 32, and not yet clamped between the male and female mold portions, the soft material 22 may be deflected by the incoming male mold portion 34 but not substantially deformed or stretched in a way that would degrade from the final product. When the female mold portion 32 and the male mold portion 34 are finally mated, the perimeter edge portion 25 is clamped between the female mold portion 32 and the male mold portion 34. Two sloping portions 26, connected to the perimeter edge portion 25, are formed in the mold cavity 36. The sloping portions 26 do not contact the protrusion 342 of the male mold portion 34 or the sidewalls of the recess 322 of the female mold portion 32.

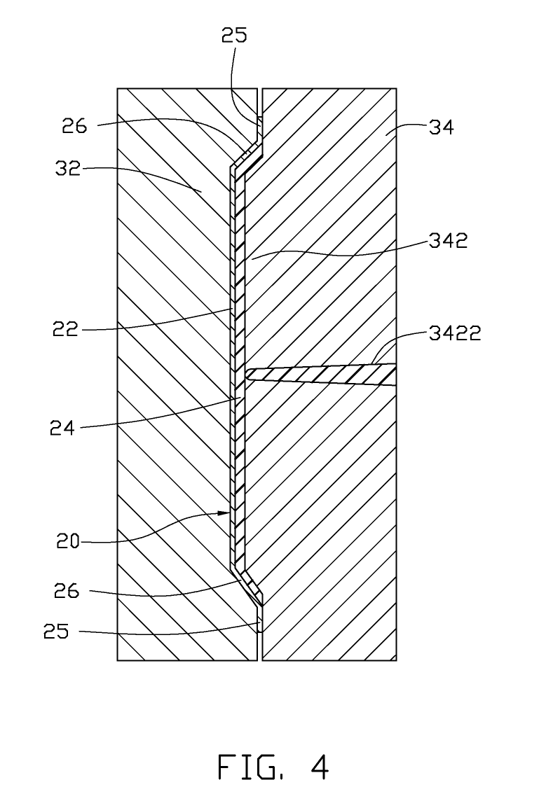

Referring to FIG. 4, after mating of the mold portions and partial deflection of the soft layer 12, molten material is injected into the mold cavity 36 through the runner 3422. The molten material pushes the soft material 22 away from, and out of contact with the protrusion 342 and further toward the female mold portion 32 and further into the mold cavity 36. As the molten material continues filling the mold cavity 36, the air and reaction gases in the mold cavity 36 flow toward the space between the sloping portions 26 and the protrusion 342 and the space between the sloping portions 26 and the sidewall of the recess 322. The air and reaction gases are then vented from the mold cavity by clearance between the male mold portion 34 and the female mold portion 32. The release of air and reaction gases during formation of the molded article 12 allows for improved stiffness in the final product. Additionally, because molten material flows from the area of runner 3422 to areas adjacent the perimeter edges of the mold apparatus, wrinkles in the soft layer 12 may be pushed toward the sloping portion 26 by the incoming molten material to decrease wrinkles in the bonding portion of the soft material 22 and achieve a better appearance.

When the soft material 22 is made of natural leather, the injected molten material will locally melt portions of the inside leather surface of the natural leather to promote bonding between the molten material and the inside surface of the soft material. When the soft material 22 is made of artificial leather, the injected molten material will locally melt the fabric base of the artificial leather to promote bonding between the molten material and the inside surface of the soft material.

The molten material is cooled and the soft material 22 integrally forms with the substrate 14 to form a semi-manufactured article 20. After the mold cavity 36 is filled, the substrate 24 is formed and the soft material 22 in the mold cavity 36 is pushed into contact with the female mold portion 32. After cooling, the male mold portion 34 is moved away from the female mold portion 32, and the semi-manufactured article 20 is taken out from the injection mold.

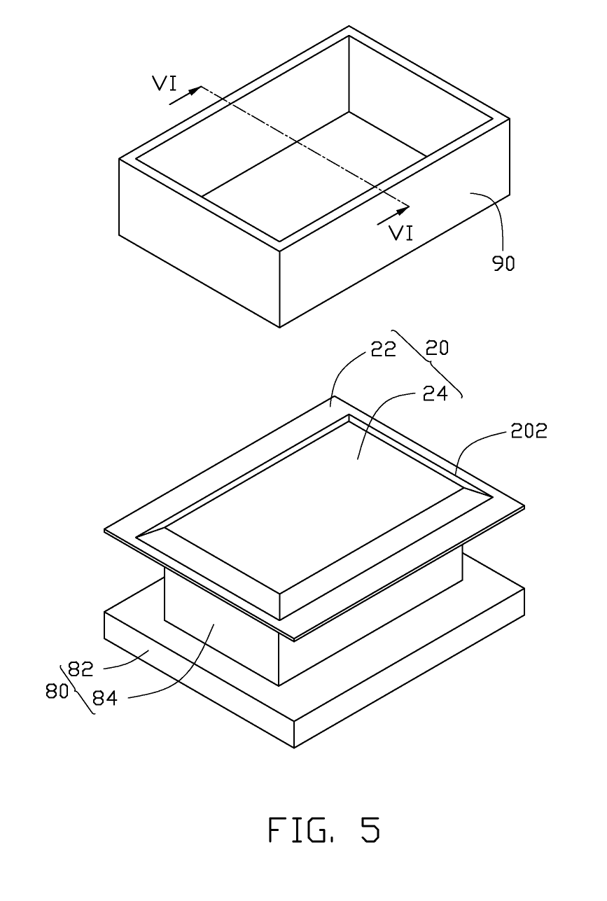

Referring to FIG. 5, the semi-manufactured article 20 has an outline 202 formed by the edge separating the angled portion and the perimeter edge portion. The portion of the semi-manufactured article 20 outside the outline 202 needs to be removed.

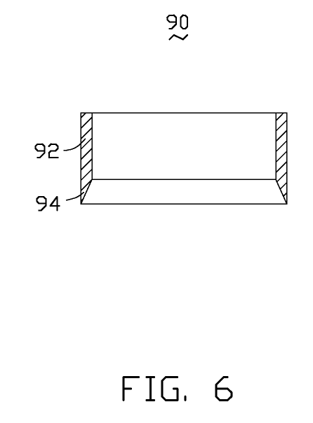

A punching machine (only a portion of which is shown) is provided and configured for performing a punching process that removes excess portions of the semi-manufactured article 20. The punching machine includes a die cutter 90 and a positioning tool 80. The position tool 80 includes a base 82 and a platform 84. The platform 84 is positioning on the base 82. Referring to FIG. 6, the die cutter 90 includes a metal frame 92 and a knife edge 94 formed on four sides. Each knife edge 94 is wedge-shape and has a predetermined configuration according to the pattern of the desired outline 202. The semi-manufactured article 20 is then fixed on the platform 84 of the positioning tool 80 of the punching machine. The metal frame 92 is heated, and the knife edges 94 are directed onto the outline 202 of the semi-manufactured article 20. The semi-manufactured article 20 is cut to a predetermined size and shape by the knife edges 94 of the punching machine, thereby forming the multi-layered molded article 10 with the soft layer 12. The multi-layered molded article 10 achieved by using the punching process may have a smooth brim and the soft layer 12 completely covering a surface of the substrate 14.

The deformation of the soft material 22 by the male mold portion 34 is small since the soft material 22 is not fixed to the female mold portion 32. Thus, the mold cavity 36 may have a high depth.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of forming a multi-layered molded article using a molding apparatus having a mold cavity, comprising:
providing a soft material having first and second surfaces;
fitting a perimeter edge portion of the soft material to a female mold of the molding apparatus such that the first surface faces the inside of the mold cavity and the second surface faces the outside of the mold cavity;
moving the male mold towards the female mold to allow a portion of the male mold to be in direct contact with a portion of the second surface of the soft material;
using the portion of the male mold to move the perimeter edge portion of the soft material and partially deflect the soft material into the mold cavity;
clamping the perimeter edge portion when the male mold engages the female mold;
injecting a molten material through the male mold portion to push the soft material away from and out of contact with the male mold and further into the mold cavity to form a substrate moldingly bonded to the soft material to form a semi-manufactured article having a soft layer;
punching the semi-manufactured article to form the multi-layered molded article.

2. The method of forming a multi-layered molded article according to claim 1, wherein the step of deflecting the soft material further comprises deflecting the soft material to form two sloping portions, the two sloping portions spaced from the female mold and the male mold before the clamping step.

3. The method of forming a multi-layered molded article according to claim 2, wherein the soft material is chosen from the group consisting of leather, fabrics, woven clothes, textiles, and nylon.

4. The method of forming a multi-layered molded article according to claim 1, wherein the punching step uses a punch cutter machine.

5. The method of forming a multi-layered molded article according to claim 4, wherein the punching machine includes a die cutter and a positioning tool, the positioning tool includes a base and a platform, the semi-manufactured article is fixed on the platform, and the die cutter cuts the semi-manufactured article.

6. The method of forming a multi-layered molded article according to claim 1, further comprising interlocking a bonding surface of the soft layer having tiny pores or protrusions that interlock with the molten material.

7. The method of forming a multi-layered molded article according to claim 7, wherein the soft material is made of artificial leather, the injected molten material locally melt a fabric base of the artificial leather.

8. The method of forming a multi-layered molded article according to claim 7, wherein the soft material is made of natural leather, the injected molten material locally melt portions of an inside leather surface of the natural leather.

9. A method of forming a multi-layered molded article by a molding apparatus including a male mold, a female mold, and a mold cavity therein, comprising:
providing a soft material into the mold cavity; wherein a perimeter edge of the soft material is freely disposed between the male mold and the female mold;
pushing the soft material until the female mold engages with the male mold, thereby clamping the perimeter edge of the soft material between the female mold and the male mold, wherein one portion of the soft material is spaced from the female mold and the male mold;
injecting a molten material through the male mold portion to push the soft material away from the male mold and into the mold cavity to form a substrate, the soft material moldingly bonding to the substrate to form a semi-manufactured article having a soft layer;
punching the semi-manufactured article using a punch cutter machine to form the multi-layered molded article.

10. The method of forming a multi-layered molded article according to claim 9, wherein the punch cutter machine includes a die cutter and a positioning tool, the positioning tool includes a base and a platform, the semi-manufactured article is fixed on the platform, and the die cutter cuts the semi-manufactured article.

11. The method forming a multi-layered molded article according to claim 10, wherein the die cutter includes a frame with a plurality of wedge-shaped knife edges.

12. The method of forming a multi-layered molded article according to claim 9, wherein the substrate is made of a material chosen from the group consisting of polyvinylchloride resin, polyethylene terephthalate, acrylonitrile-butadiene-styrene, polycarbonate, polyimide, liquid crystal polymer, polyetherimide, polyphenylene sulfide, polystyrene, polypropylene.

13. The method of forming a multi-layered molded article according to claim 9, wherein the soft material is made of natural leather or artificial leather, which endure the temperatures of the molten material on the order of 300° C. temperature.
